(19) United States
(12) Patent Application Publication
(10) Pub. No.: US 2012/0127693 A1
(43) Pub. Date: May 24, 2012

(54) LIGHT-PERMEATING COVER BOARD, METHOD OF FABRICATING THE SAME, AND PACKAGE HAVING THE SAME

(75) Inventors: Chieh-Lung Lai, Taichung (TW); Chang-Yueh Chan, Taichung (TW); Jui-Feng Lai, Taichung (TW); Chih-Sheng Hsu, Taichung (TW)

(73) Assignee: SILICONWARE PRECISION INDUSTRIES CO., LTD., Taichung (TW)

(21) Appl. No.: 13/023,239

(22) Filed: Feb. 8, 2011

(30) Foreign Application Priority Data
Nov. 23, 2010 (TW) 099140297

(51) Int. Cl. F21V 9/16; B32B 38/14; B32B 1/06; B32B 37/02

(52) U.S. Cl. 362/84; 156/60; 156/277; 428/76; 428/72

(57) ABSTRACT

A light-permeating cover board structure includes a first light-permeating board having a light-permeating substrate and a frame formed on the light-permeating substrate, wherein a first recess portion is defined by the frame and the light-permeating substrate; a first fluorescent material filled in the first recess portion; and a second light-permeating board disposed on the first light-permeating board and covering the first fluorescent material in the first recess portion. Therefore, the first light-permeating board and the second light-permeating board prevent the first fluorescent material from contacting moisture.

### BACKGROUND OF THE INVENTION

1. Field of the Invention

This invention relates to light-permeating cover board structures, and, more particularly, to a light-permeating cover board structure, a method of fabricating the light-permeating cover board structure, and a package having the light-permeating cover board structure.

2. Description of Related Art

In a modem white light-emitting diode, a silica gel material is used to protect phosphor. The silica gel material is highly light-permeating and may survive in a high temperature environment. Thus, the silica gel material may encapsulate the phosphor and isolate the phosphor from the heat generated by the white light-emitting diode. However, the silica gel material cannot prevent the phosphor from contacting moisture. Please refer to FIG. 1, which is a cross sectional view of a light-emitting diode disclosed in U.S. Pat. No. 7,023,019. A cavity 110 is formed on a base 11. Two leads 121 and 122 are installed in the cavity 110 and extend to a region outside the base 11. A light-emitting chip 13 is fixed to a bottom surface of the cavity 110, and electrically connected to the leads 121 and 122 through bonding wires 14. The cavity 110 is filled with a silica gel material 15, in which phosphor 150 are scattered.

However, the silica gel material 15 cannot prevent moisture from contacting the phosphor 150, and the phosphor 150 may thus have poor quality and cannot convert the light emitted by the light-emitting chip 13 into predetermined light having a desired color.

Therefore, how to solve the problem of the prior art is becoming one of the most popular issues in the art.

### SUMMARY OF THE INVENTION

In view of the above-mentioned problems of the prior art, the present invention provides a light-permeating cover board structure that includes: a first light-permeating board having a light-permeating substrate and a frame formed on the light-permeating substrate, wherein a first recess portion is defined by the frame and the light-permeating substrate; a first fluorescent material filled in the first recess portion; and a second light-permeating board disposed on the first light-permeating board and covering the first fluorescent material in the first recess portion.

In an embodiment, the frame is integrated with the light-permeating substrate.

The present invention further provides a method of fabricating a light-permeating cover board structure. The method includes: providing a first light-permeating board that includes a light-permeating substrate and a frame formed on the light-permeating substrate, wherein a first recess portion is defined by the frame and the light-permeating substrate; filling the first recess portion with a first fluorescent material; and disposing a second light-permeating board on the first light-permeating board to cover the first fluorescent material in the first recess portion.

In an embodiment, the first light-permeating board is made by printing the frame on the light-permeating substrate in a manner that the frame and the light-permeating substrate define the first recess portion.

In an embodiment, the first light-permeating board is made by covering the light-permeating substrate with a dry film, and patterning the dry film to form the frame so as for the first recess portion to be defined by the frame and the light-permeating substrate.

In an embodiment, a second recess portion filled with a second fluorescent material is further defined by the frame and the light-permeating substrate, wherein the second fluorescent material is different from the first fluorescent material.

The present invention further provides a package that comprises a package unit and a light-permeating cover board structure, wherein the package unit has a base and a light-emitting chip disposed on the base, and the light-permeating cover board structure is disposed on the base and includes: a first light-permeating board having a light-permeating substrate and a frame formed on the light-permeating substrate, wherein a first recess portion is defined by the frame and the light-permeating substrate; a first fluorescent material filled in the first recess portion; and a second light-permeating board disposed on the first light-permeating board and covering the first fluorescent material in the first recess portion.

In an embodiment, the package unit further comprises: a cavity formed on the base; leads disposed in the cavity and extending to a region outside the base; bonding wires electrically connected to the light-emitting chip and the leads; and a light-permeating encapsulant filled in the cavity and covering the leads, the light-emitting chip, and the bonding wires, wherein the light-emitting chip is disposed on a bottom surface of the cavity.

In an embodiment, the package further comprises a lens disposed on a portion of the light-permeating cover board structure free from contacting the package unit.

In the light-permeating cover board structure of the present invention, since the fluorescent material is filled in the recess portion, and the recess portion is covered by the first light-permeating board and the second light-permeating board, the fluorescent material will not contact moisture.

### BRIEF DESCRIPTION OF DRAWINGS

The invention can be more fully understood by reading the following detailed description of the preferred embodiments, with reference made to the accompanying drawings, wherein:

FIG. 1 is a cross sectional view of a light-emitting diode package structure disclosed in U.S. Pat. No. 7,023,019;

FIGS. 2A-2C are cross sectional views of a light-permeating cover board structure of a first embodiment according to the present invention;

FIG. 2C′ is a cross sectional view of the second light-permeating board shown in FIG. 2C that has a lens contour thereon;

FIGS. 3A-3C are cross sectional views of a light-permeating cover board structure of a second embodiment according to the present invention;

FIGS. 4A-4D are cross sectional views of a light-permeating cover board structure of a third embodiment according to the present invention;

FIG. 5A is a cross sectional view of a package of an embodiment according to the present invention;

FIG. 5B is a cross sectional view of a package of another embodiment according to the present invention; and

FIG. 5C is a cross sectional view of the package shown in FIG. 5A that has a lens thereon.

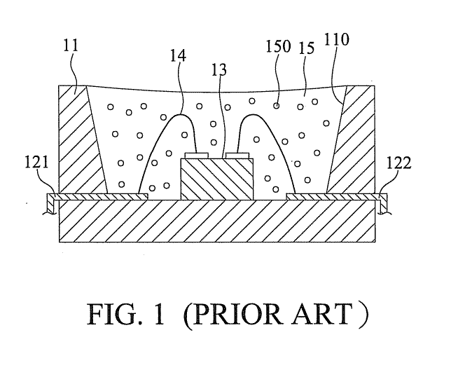

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

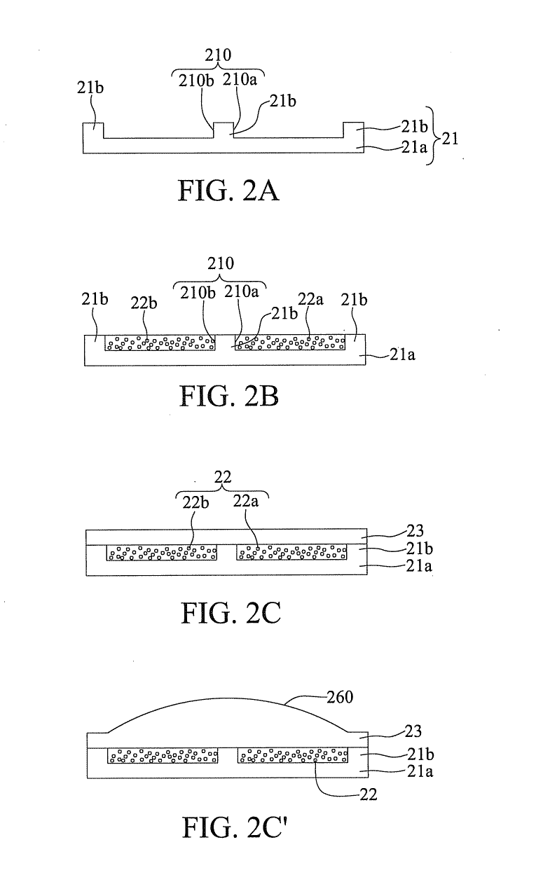

Please refer to FIGS. 2A-2C, which are cross sectional views of a light-permeating cover board structure of a first embodiment according to the present invention.

As shown in FIG. 2A, a first light-permeating board 21 is provided that is a silicon-contained substrate such as glass. The first light-permeating board 21 comprises a light-permeating substrate 21a and a frame 21b integrated on the light-permeating substrate 21a. The frame 21b and the light-permeating substrate 21a define at least a recess portion 210. A first recess portion 210a and a second recess portion 210b are exemplified in the first embodiment.

As shown in FIG. 2B, the recess portion 210 is filled with at least a fluorescent material 22. In the first embodiment, the fluorescent material 22 comprises a first phosphor 22a filled in the first recess portion 210a and a second phosphor 22b filled in the second recess portion 210b. The first phosphor 22a is different from the second phosphor 22b. Therefore, light emitted from the first phosphor 22a has a different color from that of light emitted from the second phosphor 22b, and may be blended with the light emitted from the second phosphor 22b to become light with a desired color.

As shown in FIG. 2C, a second light-permeating board 23 is disposed on the first light-permeating board 21, and covers the fluorescent material 22 in the recess portion 210. In the first embodiment, the second light-permeating board 23 is also a silicon-contained substrate such as glass.

The above method may thus fabricate a light-permeating cover board structure that comprises the first light-permeating board 21, the first light-permeating board 21 having the light-permeating substrate 21a and the frame 21b that is formed on the light-permeating substrate 21a, the frame 21b and the light-permeating substrate 21a defining at least the recess portion 210; at least the fluorescent material 22, which is filled in the recess portion 210; and the second light-permeating board 23, which is disposed on the first light-permeating board 21 and covers the fluorescent material 22 in the recess portion 210.

As shown in FIG. 2C′, a lens contour 260 is further formed on a surface of the second light-permeating board 23 free from contacting the fluorescent material 22. Likewise, another lens contour (not shown) may be further formed on a surface of the first light-permeating board 21 free from contacting the fluorescent material 22.

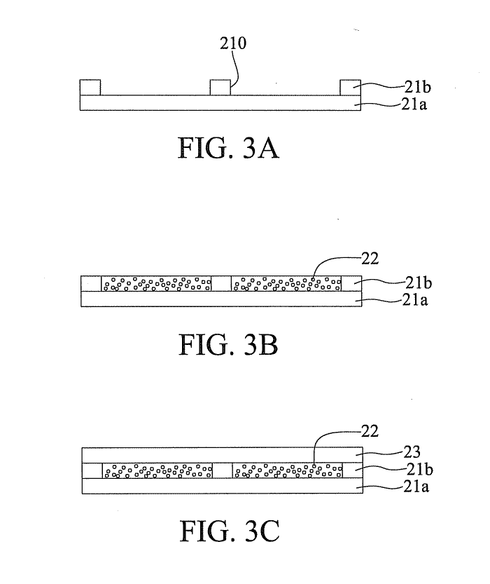

Please refer to FIGS. 3A-3C, which are cross sectional views of a light-permeating cover board structure of a second embodiment according to the present invention.

As shown in FIG. 3A, the light-permeating substrate 21a is provided, and the frame 21b is printed on and disposed on the light-permeating substrate 21a. The frame 21b and the light-permeating substrate 21a define at least the recess portion 210. The frame 21b is UV glue, B-stage epoxy resin or glass frit.

As shown in FIG. 3B, the recess portion 210 is filled with the fluorescent material 22.

As shown in FIG. 3C, the second light-permeating board 23 is formed on and disposed on the frame 21b and covers the fluorescent material 22 in the recess portion 210. In the second embodiment, the frame 21b may be further cured. If the frame 21b is the UV glue, UV light is emitted onto the UV glue to cure the UV glue to form the frame 21b; if the frame 21b is made of the B-stage epoxy resin, the B-stage epoxy resin, after being printed on the light-permeating substrate 21a, is first pre-cured and disposed on the second light-permeating board 23, and then cured to form the frame 21b; if the frame 21b is the glass frit, the glass frit, after being disposed on the second light-permeating board 23, is cured to form frame 21b.

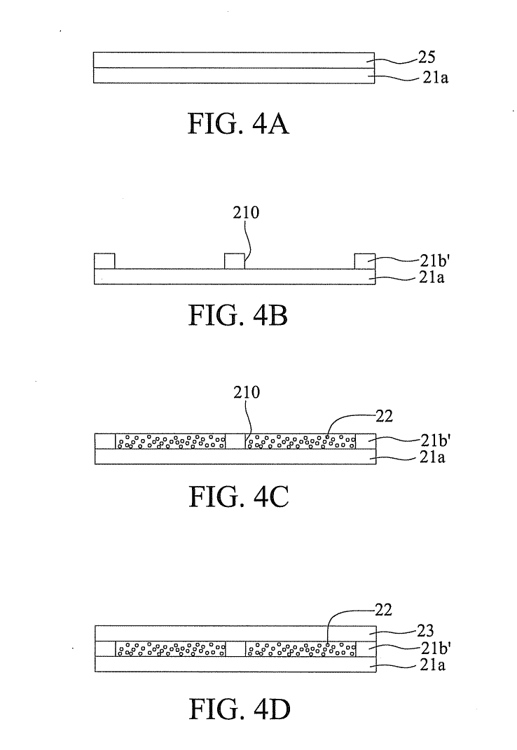

Please refer to FIGS. 4A-4D, which are cross sectional views of a light-permeating cover board structure of a third embodiment according to the present invention. The third embodiment differs from the first and second embodiments in that the frame in the third embodiment is fabricated by a method different from those used in the first and second embodiments.

As shown in FIG. 4A, the light-permeating substrate 21a is provided, and covered with a dry film 25.

As shown in FIG. 4B, the dry film 25 is patterned to form a frame 21b′. The frame 21b′ constitutes on the light-permeating substrate 21a a first light-permeating board that has at least a recess portion 210.

As shown in FIG. 4C, the recess portion 210 is filled with the fluorescent material 22.

As shown in FIG. 4D, the second light-permeating board 23 is disposed on the frame 21b′ and covers the fluorescent material 22 in the recess portion 210.

Similar to the light-permeating cover board structure disclosed in the second and third embodiments, a lens contour may further be formed on a surface of the first light-permeating board or the second light-permeating board free from contacting the fluorescent material 22.

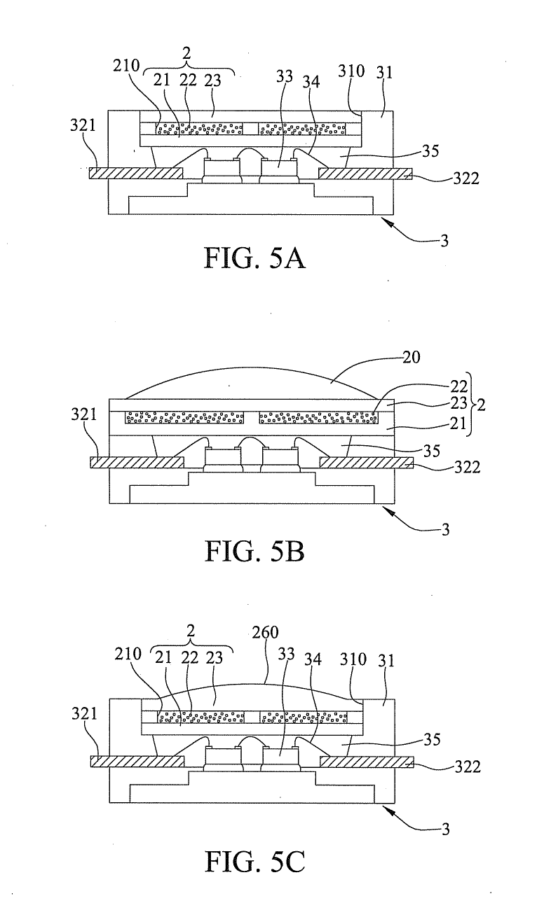

Please refer to FIGS. 5A and 5B. The present invention further provides a package. The package comprises a package unit 3 that has at least a light-emitting chip 33 and the light-permeating cover board structure 2 of the present invention. The package unit 3 comprises a base 31, a cavity 310 formed on the base 31, leads 321 and 322 disposed in the cavity 310 and extend to a region outside the base 31; the light-emitting chip 33 fixed to a bottom surface of the base 31; bonding wires 34 are electrically connected to leads 321 and 322; and a light-permeating encapsulant 35 filled in the cavity 310 and covering the leads 321 and 322, the light-emitting chip 33, and the bonding wires 34.

The light-permeating cover board structure 2 may cover the cavity 310 by the first light-permeating board 21 or the second light-permeating board 23. Please refer to FIG. 5B, a lens 20 is further disposed on a portion of the light-permeating cover board structure 2 outside the package.

Alternatively, a lens contour 260 may be further formed on a surface of the first light-permeating board 21 or the second light-permeating board 23 free from contacting the fluorescent material 22, as disclosed in the first, second and third embodiments. As shown in FIG. 5C, if the first light-permeating board 21 is disposed on and covers the cavity 310, the lens contour 260 is formed on a top surface of the light-permeating cover board structure 2 (i.e., a surface of the second light-permeating board 23), a step of disposing the lens 20 hereby omitted.

In the light-permeating cover board structure, the method of fabricating the light-permeating cover board structure, and the package having the light-permeating cover board structure of the present invention, the first light-permeating board of the light-permeating cover board structure has at least the recess portion, the recess portion is filled with the fluorescent material, and the second light-permeating board is disposed on the first light-permeating board and covers and encapsulates the fluorescent material in the recess portion. Therefore, the fluorescent material is prevented from contacting moisture.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A light-permeating cover board structure, comprising:
a first light-permeating board having a light-permeating substrate and a frame formed on the light-permeating substrate, such that a first recess portion is defined by the frame and the light-permeating substrate;
a first fluorescent material filled in the first recess portion; and
a second light-permeating board disposed on the first light-permeating board and covering the first fluorescent material in the first recess portion.

2. The light-permeating cover board structure of claim 1, wherein the first light-permeating board is a silicon-contained substrate.

3. The light-permeating cover board structure of claim 1, wherein the second light-permeating board is a silicon-contained substrate.

4. The light-permeating cover board structure of claim 1, wherein the frame is made from a dry film, or made of UV glue, epoxy resin or glass frit.

5. The light-permeating cover board structure of claim 1, wherein the frame is integrated with the light-permeating substrate.

6. The light-permeating cover board structure of claim 1, wherein a lens contour is formed on a surface of the first light-permeating board or the second light-permeating board free from contacting the first fluorescent material.

7. The light-permeating cover board structure of claim 1, further comprising a second fluorescent material different from the first fluorescent material, so as for a second recess portion filled with the second fluorescent material to be further defined by the frame and the light-permeating substrate.

8. A method of fabricating a light-permeating cover board structure, comprising:
providing a first light-permeating board having a light-permeating substrate and a frame formed on the light-permeating substrate, wherein a first recess portion is defined by the frame and the light-permeating substrate;
filling the first recess portion with a first fluorescent material; and
disposing a second light-permeating board on the first light-permeating board to cover the first fluorescent material in the first recess portion.

9. The method of claim 8, wherein the first light-permeating board is a silicon-contained substrate.

10. The method of claim 8, wherein the second light-permeating board is a silicon-contained substrate.

11. The method of claim 8, wherein the frame is integrated with the light-permeating substrate.

12. The method of claim 8, wherein the first light-permeating board is made by printing the frame on the light-permeating substrate in a manner that the frame and the light-permeating substrate define the first recess portion.

13. The method of claim 12, wherein the frame is made of UV glue, epoxy resin or glass frit.

14. The method of claim 12, further comprising curing the frame.

15. The method of claim 8, wherein the first light-permeating board is made by:
covering the light-permeating substrate with a dry film;
patterning the dry film to form the frame so as for the first recess portion to be defined by the light-permeating substrate and the frame.

16. The method of claim 8, further comprising forming a lens contour on a surface of the first light-permeating board or the second light-permeating board free from contacting the first fluorescent material.

17. The method of claim 8, wherein a second recess portion filled with a second fluorescent material is further defined by the frame and the light-permeating substrate, and wherein the second fluorescent material is different from the first fluorescent material.

18. A package, comprising:
a package unit having a base and a light-emitting chip disposed on the base; and
a light-permeating cover board structure disposed on the base, the light-permeating cover board structure comprising:
a first light-permeating board having a light-permeating substrate and a frame formed on the light-permeating substrate, wherein a first recess portion is defined by the frame and the light-permeating substrate;
a first fluorescent material filled in the first recess portion; and
a second light-permeating board disposed on the first light-permeating board and covering the first fluorescent material in the first recess portion.

19. The package of claim 18, wherein the package unit further comprises:
a cavity formed on the base;
leads disposed in the cavity and extending to a region outside the base;
bonding wires electrically connected to the light-emitting chip and the leads; and
a light-permeating encapsulant filled in the cavity and covering the leads, the light-emitting chip, and the bonding wires,
wherein the light-emitting chip is disposed on a bottom surface of the cavity.

20. The package of claim 18, further comprising a lens disposed on a portion of the light-permeating cover board structure free from contacting the package unit.
